(19) United States
(12) Patent Application Publication
(10) Pub. No.: US 2018/0281468 A1
(43) Pub. Date: Oct. 4, 2018

(54) PRINTING DEVICE TO OPERATE IN A SELECTED OPERATING MODE

(71) Applicant: Hewlett-Packard Development Company, L.P., Houston, TX (US)

(72) Inventors: Joan Albert Jorba Closa, Sant Cugat del Valles (ES); Ronald Albert Askeland, San Diego, CA (US); Francisco Javier Perez Gellida, Sant Cugat del Valles (ES); Joan Sole Rodes, Sant Cugat del Valles (ES)

(73) Assignee: Hewlett-Packard Development Company, L.P., Houston, TX (US)

(21) Appl. No.: 15/760,154

(22) PCT Filed: Dec. 17, 2015
(86) PCT No.: PCT/EP2015/080362

§ 371 Date: Mar. 14, 2018

(51) Int. Cl. B41J 11/00; B41J 2/21

(52) U.S. Cl. CPC B41J 11/002; B41J 2/2103

(57) ABSTRACT

An example printing device composing a first printhead and a second printhead is described. In some examples the example printing device comprises a controller. The example printing device is to operate in a first operating mode in which the first printhead is to dispense a first printing substance, the first printing substance to transfer color via a first colorant transfer mechanism, and to operate in a second operating mode in which the second printhead is to dispense a second printing substance, the second printing substance to transfer via a second colorant transfer mechanism different to the first colorant transfer mechanism. An example controller is to cause the example printing device to operate in a selected one of the first and second operating modes.

### BACKGROUND

Some printing devices have a reservoir to stem printing fluid, such as ink, and a supply system to supply the printing fluid from the reservoir to a printhead, to enable the printhead to apply the printing fluid to a substrate to form an image on the substrate during a print job. Many printing devices incorporate some form of relative movement between the print medium and the printhead so that printing fluid is deposited onto an appropriate area of the print medium. For example, the printhead may be carried by a carriage that, in use, scans over the substrate to apply the printing fluid to form the image.

The printing fluid may comprise an ink vehicle that acts to carry a pigment or dye to the substrate. The pigment or dye fends color to the printed image.

### BRIEF DESCRIPTION OF THE DRAWINGS

Various features of the present disclosure will be apparent from the detailed description which follows, taken in conjunction with the accompanying drawings, which together illustrate, by way of example, features of the present disclosure, and wherein:

FIG. 1 is a schematic diagram showing a plan view of a printing device according to an example;

FIG. 2 is a schematic diagram showing a carriage according to an example;

FIG. 3 is a schematic diagram showing an arrangement of printheads according to an example;

FIG. 4a is a schematic diagram showing a curing module according to an example;

FIG. 4b is a schemata diagram showing a curing module according to an example;

FIG. 5 is a schematic diagram showing a film of printing fluid according to an example;

FIG. 6a is a schematic diagram showing drying of a printing fluid according to an example;

FIG. 6b is a schematic diagram showing curing of a printing fluid according to an example;

FIG. 7 is a schematic diagram showing a film of printing fluid according to an example;

FIG. 8a is a schematic diagram showing drying of a printing fluid according to an example;

FIG. 8b is a schematic diagram showing curing of a printing fluid according to an example; and

FIG. 9 is a flow diagram illustrating a method of operating a printing device, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

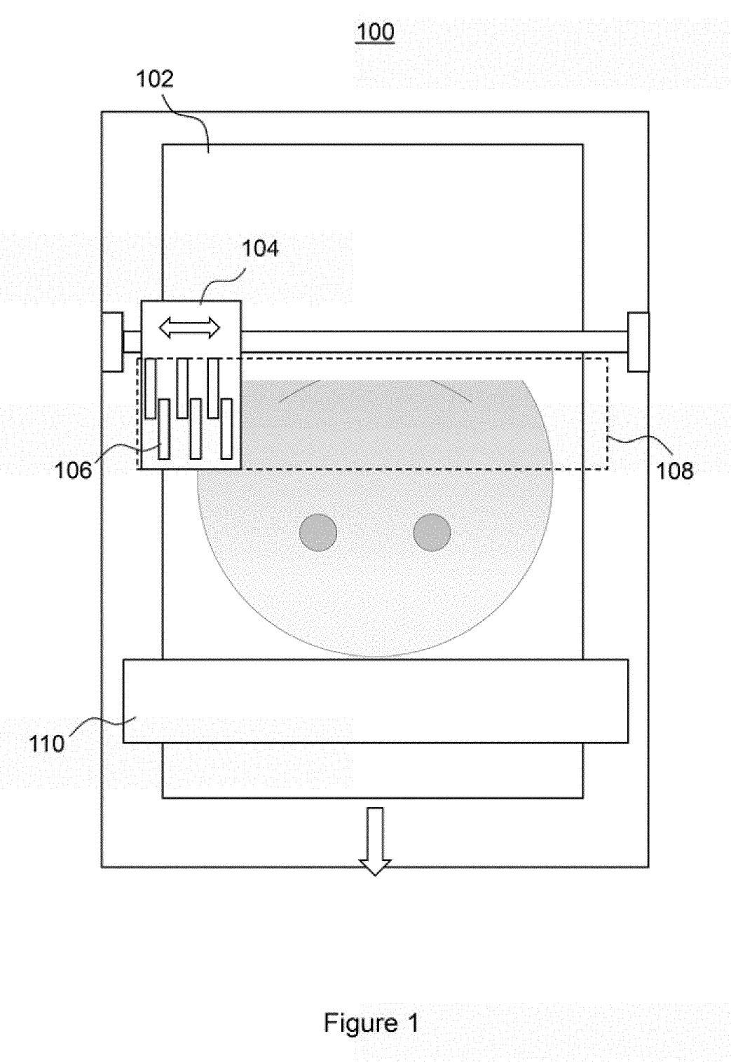

FIG. 1 schematically illustrates a plan view of the components of a printing device, referred to hereinafter as a printer 100, which is an example system used to illustrate the features of the present application. FIG. 1, as well as other figures referenced herein, are schematic diagrams and as such certain components have been omitted to facilitate a description of the example. Actual implementations may vary in practice.

The printer 100 is to print a desired image onto a print target (referred to herein as a substrate 102). In the example shown in FIG. 1, the substrate 102 Is transported through the printer 100 in a downstream direction, indicated in FIG. 1 by a single-head arrow. However, in some examples, such as 3D printers, the substrate may be stationary and the printhead may move relative to the stationary substrate. The substrate 102 may be supplied as a single sheet or from a continuous roll or, in the case of a 3D printer, may be a bed of build material.

The printer 100 may be, for example, an inkjet printer. In the example shown in FIG. 1, the printer 100 comprises a carriage 104 to carry at least one printhead 106. In other examples, the printer 100 may instead comprise a print bar that laterally extends across a printable width of the substrate 102, in a so-called ‘page-wide’ array

The desired image is communicated to the printer 100 in digital form. The desired image may include any combination of text, graphics and images. In certain implementations, the printer 100 may have a controller that receives data from an image processing unit (not shown). The data received by the controller is used to control the position of the carriage 104 and to control how printing fluid (referred to hereinafter as ink) is ejected from the printheads 106 to print the image.

Printing fluid, referred to herein as ink, is ejected onto the substrate 102, through the printheads 106, which generally include a plurality of ink drop generators that comprise nozzles. The printheads 106 and nozzles can be incorporated into the carriage 104, or be a removable insert positioned within the carriage 104. In any case, ink supplied to the printheads 106 may be selectively ejected as droplets of ink onto the substrate 102 as the carriage 104 traverses beck and forth from one side of the printer 100 to the other in a bi-directional fashion (as indicated by the double-headed arrow in FIG. 1). The region located immediately under the scanning printheads 106, in which ink droplets are applied to the substrate 102, is referred to herein as a print zone 108.

The carriage 104 may also carry components to perform other functions. For example, the carnage may comprise a dryer and/or an aerosol extraction

After the image is formed on the substrate 102, the substrate passes a post-printing heater in a region referred to generally herein as a curing zone 110.

Ink may be supplied to the printheads 106 from ink reservoirs (not shown). Each ink reservoir may contain, for example, a different color ink. The ink reservoirs may be located within the printheads 106 or may be located remotely from the printheads 106 and connected to the printheads 106 by ink supply lines.

The ink may comprise an ink vehicle and a colorant. The ink may also comprise at least, one co-solvent and/or et least one additive such as a wetting agent and/or a humectant.

The ink vehicle is a fluid for transporting the colorant to the substrate 102.

The colorant may be, for example, a pigment or a dye to lend color to the printed image.

The mechanism by which color is transferred to the substrate 102, referred to herein as the colorant transfer mechanism, may depend of the particular printing technology and/or the ink vehicle being used.

For example, aqueous inks comprise a water-based ink vehicle with either dye dissolved in the water or pigment particles suspended in the water. Dye-based aqueous inks soak Into the substrate 102 and stain the substrate 102 as the water-based ink vehicle evaporates. In pigment-based aqueous inks, the pigment particles bond to the surface of the substrata 102 as the water-based ink vehicle evaporates.

In another example, solvent inks comprise a solvent ink vehicle generally having pigment particles suspended in the solvent. Similar to aqueous pigment-based inks, as the solvent ink vehicle evaporates, the pigment particles bond to the surface of the substrate 102.

In another example, the ink may comprise a water-based ink vehicle in which polymer particles and colorant particles are suspended. The ink vehicle may also comprise co-solvents and additives. After ink is ejected onto the substrate 102, it may be exposed to host to evaporate the water ink vehicle. A second heating stage may cause the polymer particles to coalesce to form a polymer film hiding the colorant particles to the substrate 102. An example of such inks are latex inks.

In another example, a solvent or water based ink vehicle may comprise a sublimation dye. After the ink is ejected onto the substrate 102, it may be exposed to heat causing the dye to sublimate (i.e. transition from a solid phase into a vapor phase) in which it penetrates and binds to the substrate 102.

In another example, the ink may comprise pigment and/or dye colorant and an ultraviolet (UV) curable ink vehicle. After ink is ejected onto the substrate 102, it may be exposed to UV radiation to cure the resin and fix the colorant onto the substrate 102.

The type of colorant transfer mechanism and/or the type of ink vehicle used in a particular printing process may be dependent upon the type of substrate 102 and/or the process for drying or curing the ink. For example, inks that dry by absorption into the substrate 102 may utilize oil vehicles that do not evaporate before they can be absorbed into the substrate, whereas inks that dry via evaporation may utilize water-based or solvent vehicles.

Certain ink vehicle types may exhibit compatibility issues with other ink vehicle types. For example, some ink vehicle types may be insoluble or immiscible in other ink vehicle types. Some ink vehicle types may react chemically with other ink vehicle types or may alter the viscosity of other ink vehicle types. There is therefore a concern about using inks utilizing different colorant transfer mechanisms and/or having different vehicle types in the same printing device; namely that doing so may result in cross-contamination of the inks.

Some ink vehicle types are suitable for printing on some substrates but not others. In examples where an ink vehicle type is not suitable for printing on a particular substrate, a different printer, utilizing a different ink vehicle type, may be used to print onto that substrate.

Efforts to increase the range of substrates available for printing in a particular printer have concentrated on developing inks that are able to be used on a broader range of media.

Where such inks have not been developed, to use an ink that utilizes a different ink vehicle type in a given printer, the printhead and any ink supply lines may be flushed and then primed with the ink utilizing a different ink vehicle type. This results in significant downtime each time a substrate requiring a different ink vehicle type is to be printed on. Furthermore, as the printer is not to dry or cure the ink utilizing the different ink vehicle, the printed substrate may be further processed using in-line dryers or off-line print storage in which the ink vehicle can be evaporated or cured before being handled.

In an example, a printing device comprises a first printhead, a second printhead, and a controller. The printing device is to operate in a first operating mode in which the first printhead is to dispense a first printing substance, the first printing substance to transfer color via a first colorant transfer mechanism, and to operate in a second operating mode in which the second printhead is to dispense a second printing substance, the second printing substance to transfer color via a second colorant transfer mechanism different to the first colorant transfer mechanism. The controller is to cause the panting device to operate in a selected one of the first and second operating modes.

In another example, a printing device comprises: a first printhead to print a first printing substance to transfer color via a first colorant transfer mechanism, a second printhead to print a second printing substance to transfer color via a second colorant transfer mechanism different to the first colorant transfer mechanism, and a curing module to operate in s first operating mode to fix the first printing substance when the first printhead is used to print the first printing substance, and to operate in a second operating mode, different to the first operating mode, to fix the second printing substance when the second printhead is used to print the second printing substance.

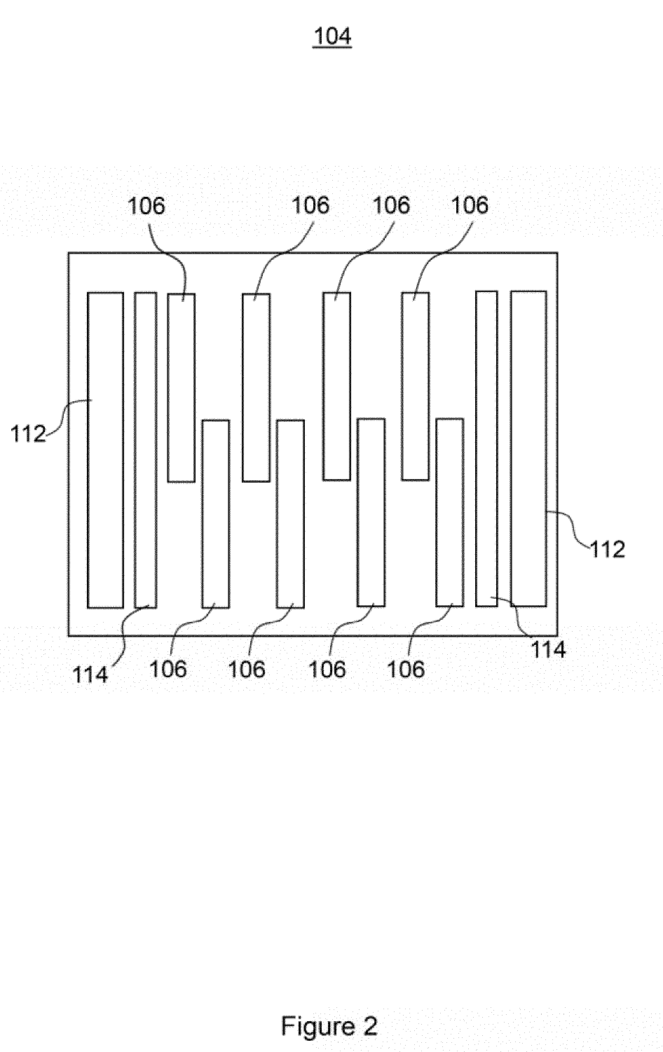

FIG. 2 schematically illustrates the components of a carriage 104 according to an example. The carnage 104 shown in FIG. 2 comprises eight printheads 106. The carriage also comprises two print zone dryers 112, and two aerosol extraction modules 114. It will be understood that in some examples, the carriage may carry other numbers of printheads 106, other numbers of print zone dryers 112, and other numbers of aerosol extraction modules 114. It will also be understood that in some examples, the print zone dryers 112 and/or the aerosol extraction modules 114 may be omitted from the carriage 104. The print zone dryers 112 may be, for example, near-infrared (“NIR”) heating lamps which direct infrared radiation and/or hot air from the lamps towards ejected ink as the carriage 104 scans across the substrate 102.

In some examples, the printheads 106 may each be to print a different ink. For example, each printhead 106 may be to print a single type of ink and/or a single color of ink. At least one of the printheads 106 may be to print an ink primer. In some examples, the printheads 106 may comprise bicolor printheads, in which a given printhead 106 comprises two columns of nozzles, one of the columns being to print a different color ink to the other column. For example, one printhead 106 may be to print back and cyan and one printhead 106 may be to print magenta and yellow.

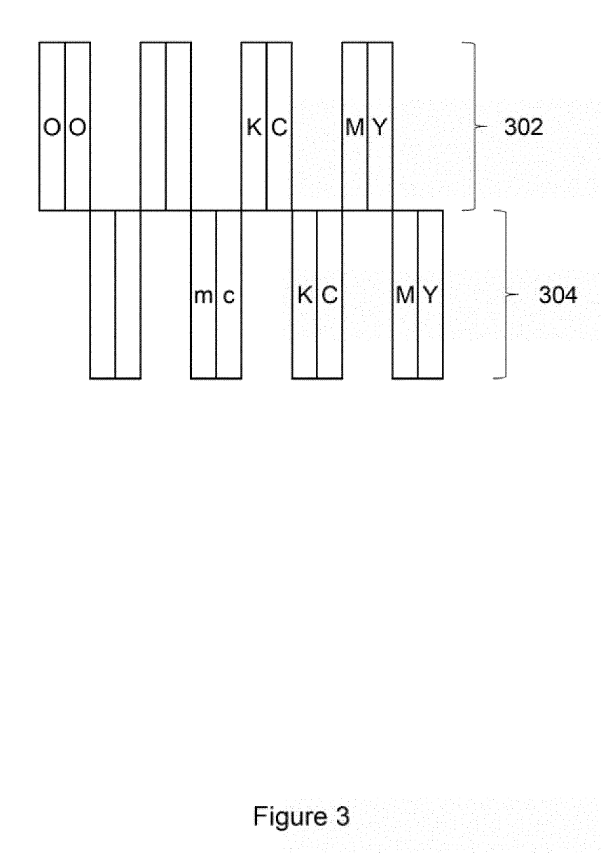

FIG. 3 illustrates the layout of printheads 106 in a print carnage 104 according to an example. The printheads 106 are in two rows of printheads 106. In a first row of printheads 302 are printheads 106 to print ink that utilizes a first colorant transfer mechanism and/or comprises a first ink vehicle type, in a second row of printheads 304 are printheads 106 to print ink that utilizes a second colorant transfer mechanism and/or comprises a second ink vehicle type.

In some examples, each row of printheads 302, 304 has the same set of colors available for printing. However, as shown in FIG. 3, in some examples, the first row 302 of printheads 106 may comprise a different set of color to the second row 304 of printheads 106. For example, as shown in FIG. 3, the first, row 302 may be for dye sublimation printing and comprise a latex optimizer printhead O, a black/cyan dye sublimation printhead KC, and a magenta/yellow dye sublimation printhead MY, while the second row 304 may be for latex printing and comprises a light magenta/light cyan latex printhead mc, a black/cyan latex printhead KC, and a magenta/yellow latex printhead MY.

The printheads 106 that are to print may be determined according to an operating mode of the printer. Accordingly, a controller (not shown) may cause the printing device to operate in a selected operating mode. The operating mode may be selected by an operator or may be selected by the controller, for example on the basis of the type of substrate 102 on which the ink is to be printed.

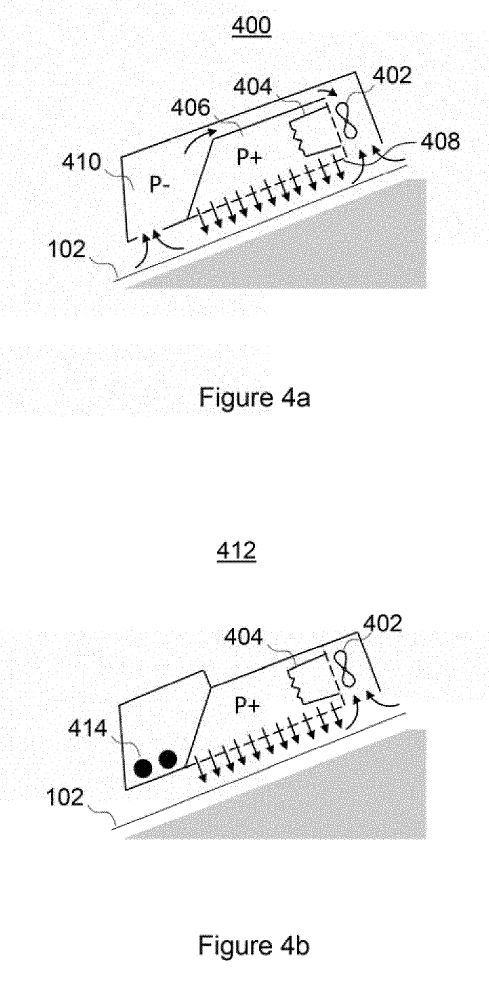

FIGS. 4a and 4b illustrate examples of a curing module in the curing zone 110. In some examples, the curing zone 110 may comprise plural such curing modules. The curing modules may be to dry, cure, or heat fixate ink in the curing zone 110.

FIG. 4a illustrates components of a first example of a curing module 400. The curing module 400 comprises a fan 402 and a heater 404. The fan 402 drives air through the heater 404 into a positive pressure chamber 408. Warmed air in the positive pressure chamber 406 passes through a nozzle plate 408 that directs warm air onto the substrate 102. Air taken in by the fan 402 may comprise fresh air and air that is recirculated by being drawn into a relatively negative pressure chamber 410, as shown in FIG. 4a.

FIG. 4b illustrates components of a second example of a curing module 412. The second example of the curing module 412, may comprise a fan 402 driving a heater 404 to heat the substrate 102 in the manner described above with reference to FIG. 4a. The curing module 412 may additionally comprise an irradiating element 414. The irradiating element 414 may provide an additional mechanism for heating and/or curing ink applied to the substrate 102.

In some examples, the irradiating element 414 may be to emit infrared (IR) radiation. For example, the irradiating element 414 may be to apply heat to the substrate at a temperature higher than that provided by the fan 402 and heater 404.

In some examples, the irradiating element 414 may be to emit ultraviolet (UV) radiation. For exam pie, the irradiating element 414 may be to cure UV curable ink.

In some examples, the irradiating element 414 may emit both IR and UV radiation.

In some examples, the printer 100 may comprise a controller to control the curing module 400, 412 according to an operating mode. For example, the curing module 400, 412 may operate in a first operating mode to fix ink that is ejected by the first row 302 of printheads 106 onto the substrate 102, and operate in a second operating mode, different to the first operating mode, to fix ink ejected by the second row 304 of printheads 106 onto the substrate 102.

In an example, the printer 100 may print an aqueous-dispersed polymer, such as latex inks, m a first mode and print a dye sublimation ink in a second mode.

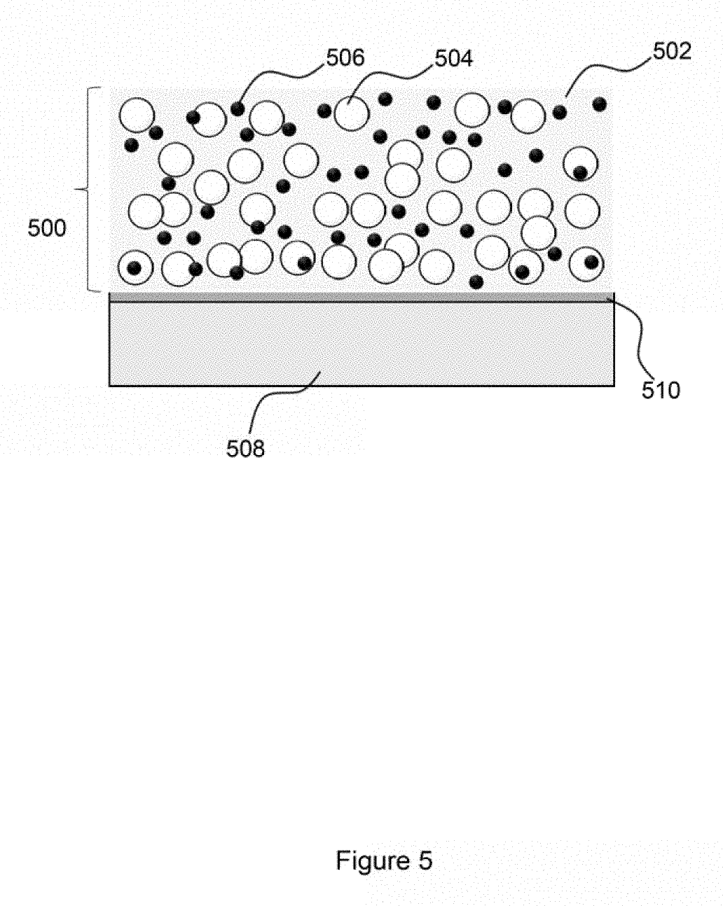

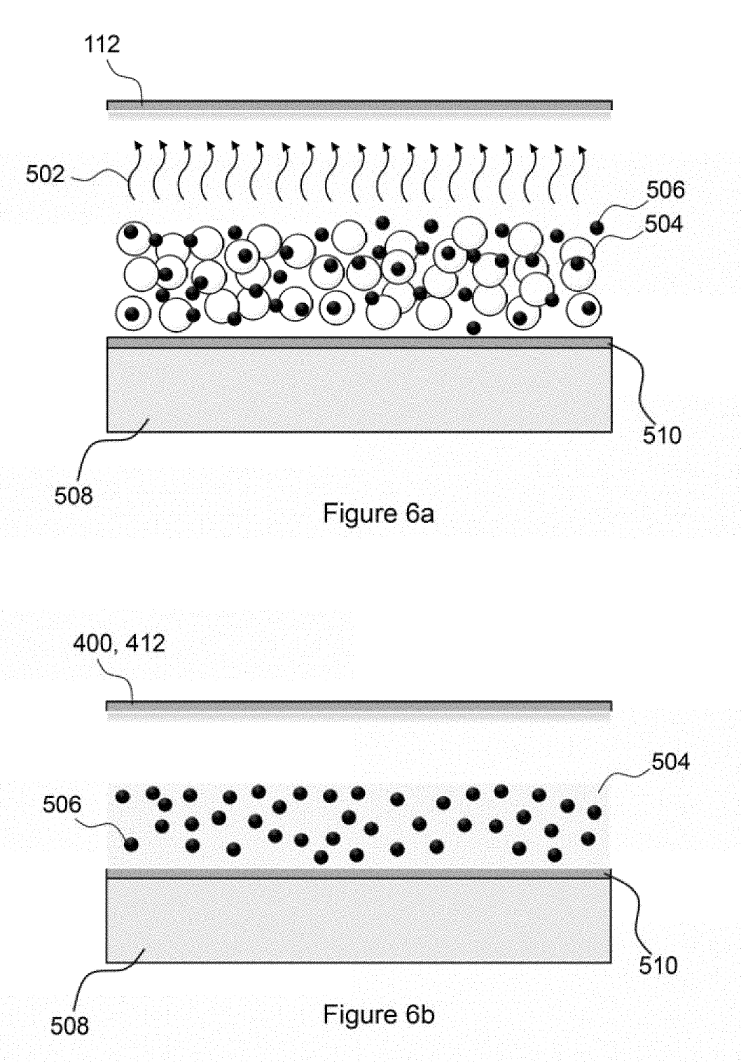

FIGS. 5, 6a and 6b schematically illustrates operation of the printer 100 operating in the first mode.

In the print zone 108, a liquid film 500 of latex ink is printed on the surface of a substrate 102. The film 500 may be ejected, for example, from printheads 106 in the second row 304, as described above.

The film 500 may comprise a mixture of a water-based ink vehicle 502, latex polymer particles 504, and pigment particles 506. This type of ink is suitable for printing on non-absorbent substrates. The composition of the ink vehicle 502 may be, for example, 70% water, 30% co-solvent and additives.

In the example shown in FIG. 5, the substrate may be a vinyl substrate 508.

Co-solvents and additives mixed with the ink vehicle 502 may aid in wetting the surface to allow a droplet to spread onto the substrate to form a liquid film The co-solvents also act to form a layer of softened vinyl 510 on the surface of the vinyl substrate 508 to prepare the vinyl substrate 508 for chemical interaction with the latex polymer particles 404 for better adhesion of the film 500.

FIGS. 6a and 6b schematically illustrate the drying and curing process for fixing the latex film 500 to the vinyl substrate 508. FIG. 6a shows the film in the print zone 108 and FIG. 6b shows the film In the curing zone 110.

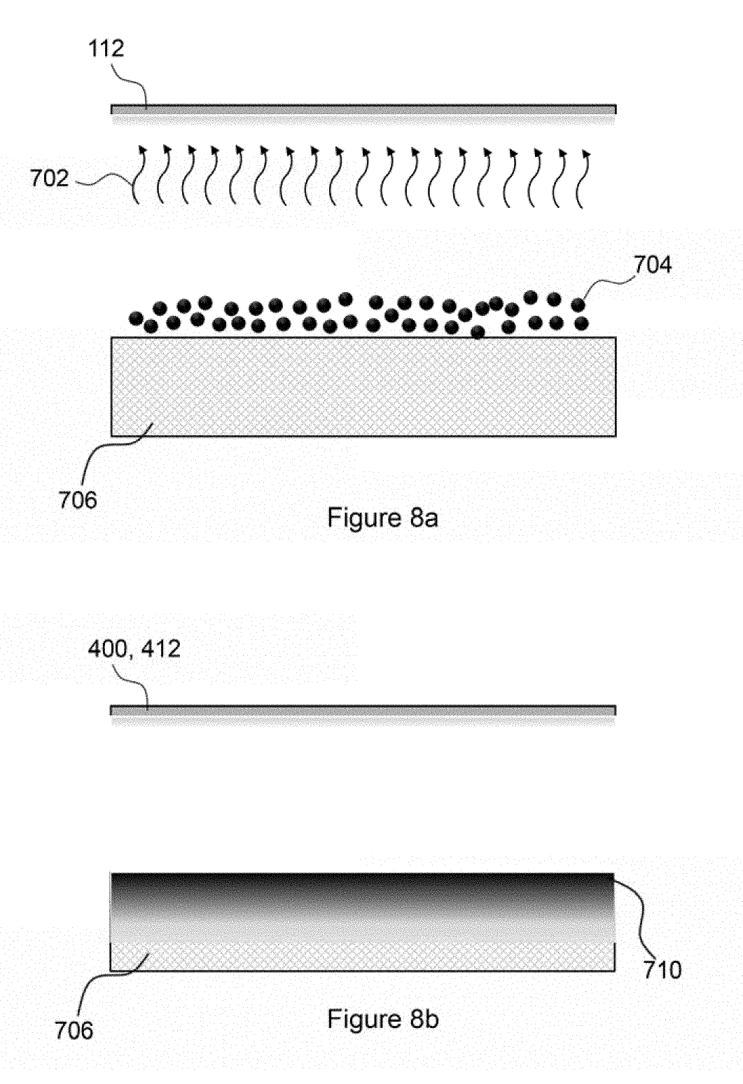

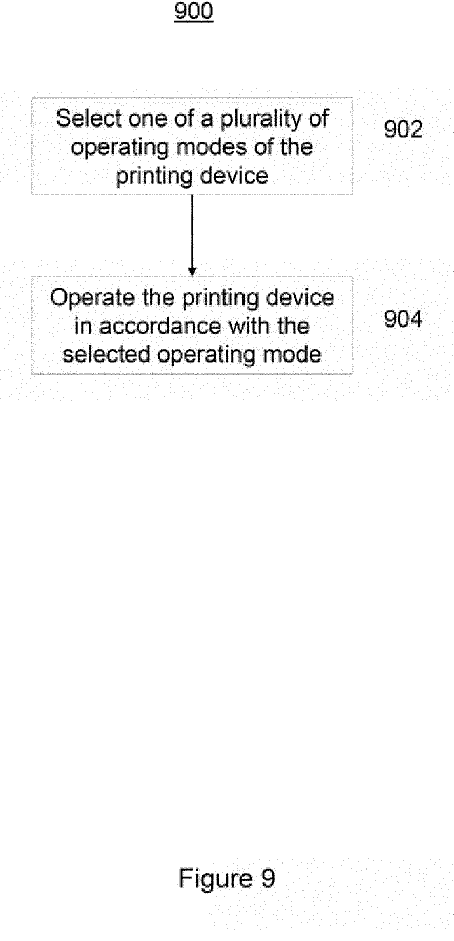

As shown in FIG. 8a, in the print zone 108, the film is heated by, for example, the drying heaters 112. Heat from the drying heaters 112, and forced airflow, causes the ink vehicle 502 to evaporate so that the liquid film 500 condenses to a viscous mixture of latex polymer particles 504, pigment particles 506 and co-solvents. The higher viscosity of the condensed ink film immobilizes the polymers particles 504 and pigment particles 506 to set the dot size and to minimize coalescence and bleed with dots in neighboring print locations.

As shown in FIG. 6b, in which the vinyl substrate 508 has been advanced out of the print zone 108 and Into the curing zone 110, a second heater, which may comprise a curing module 400, 412 as discussed above with reference lo FIGS. 4a and 4b, applies heat to the condensed film. For example, the curing module 400, 412 of the second heater may cure the latex ink at a temperature in the range 60° C.-125° C. In some examples, the curing module 400, 412 of the second heater may cure the latex ink at 100° C. for 60 seconds.

Heating in the curing zone 110 evaporates the co-solvents and causes the latex polymer particles 504 to coalesce into a continuous polymer film that encapsulates the pigments particles 506. The dense film of latex particles 504 chemically bonds to the softened vinyl surface 510 of the vinyl substrate 508 to form a durable colored film.

The printing process described above with reference to FIGS. 8a and 8b is suitable for printing on a wide range of substrate types including, amongst others, plain paper, glossy paper, coated paper, transparencies, vinyl, polyvinylchloride (PVC), and metal foils. However, adhesion of ink utilizing this type of vehicle onto certain substrates may not be optimal. For example, inks utilizing other types of colorant transfer mechanism and/or other types of ink vehicle, which are perhaps incompatible with the ink used in the process of FIGS. 6a and 6b, may adhere better to textile substrates, such as polyester fabric. Conversely, inks utilizing a colorant transfer mechanism and/or an ink vehicle that performs well on textile substrates may not perform well on other substrate types.

For example, dye sublimation inks perform well on polyester fabrics, but do not perform well on other types of substrate.

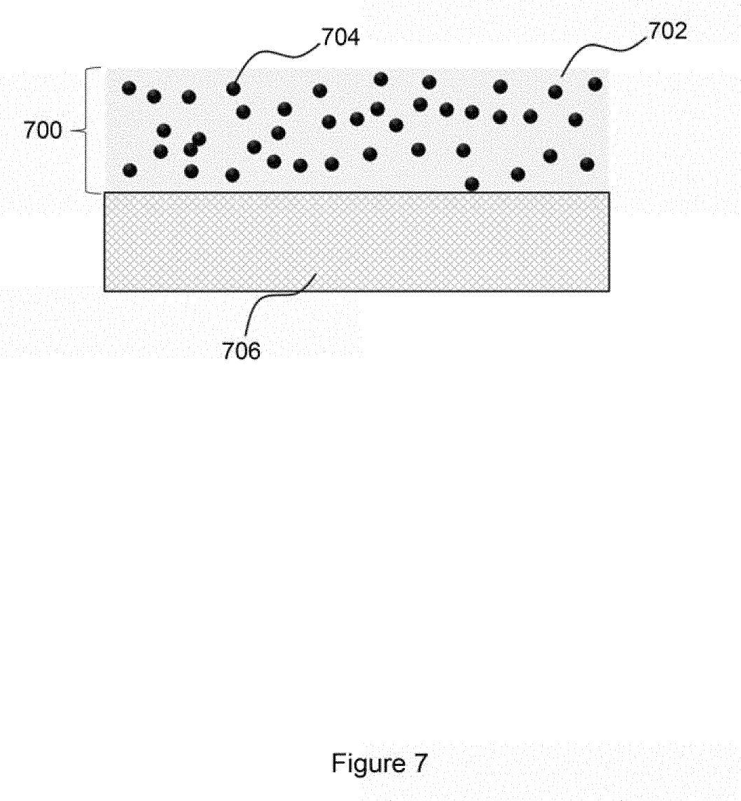

FIGS. 7, 8a and 8b schematically illustrates operation of the printer 100 operating in the second mode.

In the print zone 108, a liquid film 700 of dye sublimation ink is printed on (he surface of a substrate 102. The film 700 may be ejected, for example, from printheads 106 (KC and MY) In the first row 302, as described above.

The film 700 may comprise a mixture of a water-based ink vehicle 702, and dye sublimation particles 704. This type of ink is suitable for printing on textiles.

In the example shown in FIG. 7, the substrate may be a polyester fabric substrate 706.

FIGS. 8a and 8b schematically illustrate the drying and curing (heat fixation) process for fixing the dye sublimation film 700 to the polyester fabric substrate 706. FIG. 8a shows the film in the print zone 108 and FIG. 8b shows the film in the curing zone 110.

As shown in FIG. 8a, in the print zone 108 the film is heated by, for example, the drying heaters 112. Heat from the drying heaters 112, and forced airflow, causes the ink vehicle 702 to evaporate so that the liquid film 700 condenses to a layer of dye sublimation particles 704.

As shown in FIG. 8b, in which the polyester fabric substrate 706 has been advanced out of the print zone 108 and into the curing zone 110, a second heater, which may comprise curing modules 400, 412 as discussed above with reference to FIGS. 4a and 4b, applies heat to the condensed film. For example, the curing modules 400, 412 of the second heater may cure (heat fixate) the dye sublimation ink at a temperature in the range 150° C.-220° C. In some examples, the curing modules 400, 412 of the second heater may heat the dye sublimation ink at 200° C. for 30 seconds.

Heating in the curing zone 110 causes the dye sublimation particles 704 to sublimate into a vapor that penetrates and condenses onto the polyester fabric substrate 706. The condensed pigment bonds to fibers in the fabric substrate 306 to form a durable colored layer 710.

The printing process described above with reference to FIGS. 8a and 8b is suitable for printing on a wide range of substrate types including, amongst others, fabrics and textiles. However, adhesion of ink utilizing this type of vehicle onto certain substrates may not be optimal. For example, inks utilising other types of ink vehicle, which are perhaps incompatible with the ink vehicle used in the process of FIGS. 8a and 8b, may adhere better to polymer film substrates, such as vinyl films.

In some examples, ink transfer mechanisms different from the latex printing process and the dye sublimation process may foe performed by the printer 100 in one of its modes. For example, the printer 100 may in one mode perform UV cured printing in which some of the printheads 106 eject UV curable ink onto the substrate 102 and a curing module 410 irradiates the ink in the curing zone 110 with UV radiation.

In some examples, the printer 100 may be able to operate in more than two modes. For example, the printer 100 may operate in a first mode in which latex ink is printed, a second mode in which dye sublimation ink is printed, and a third mode In which UV curable ink is printed.

In some examples, the printer 100 may print in a mode in which more than one type of Ink is printed on the same substrate during a printing event. For example, the printer 100 may print on polyester textile with dye sublimation ink and UV curable ink, or with dye sublimation ink and latex ink. This may enable the printer 100 to produce novel graphical effects. For example dye sublimation ink may be printed in some areas in order to get bright colors and match the texture and gloss of the fabric, while UV curable and/or latex inks may be printed in other areas to obtain a thicker, stiffer ink layer, or a layer of ink with different gloss properties.

In another example, the printer 100 may print colored dye sublimation ink and white latex ink on a dear polyethylene terephthalate (PET) substrate. The dye sublimation ink may be used to print colored portions of an image and the latex ink may be used to underprint or overprint white sections of the image. This extends the application of dye sublimation inks to clear PET substrates as white dye sublimation inks are not available.

In another example, the printer 100 may be used to print latex or solvent inks to print a relatively thin layer of colorant (e.g. <2 μm thick) on signage media in certain areas of the substrate and to print UV curable Inks to create an ink layer that is relatively thicker (e g. 5-20 μm thick), with different gloss, in other areas of the substrate.

FIG. 10 is a flow diagram illustrating a method 1000 of operating the printer 100, according to an example.

At block 1002, the controller of the printing device 100 selects one of a plurality of operating modes of the printing device. The operating modes comprise a first operating mode in which a first printing substance is dispensed from a first printhead of the printing device and a second operating mode in which a second printing substance is dispensed from a second printhead of the printing device. The first printing substance may be to transfer color via a first colorant transfer mechanism the second printing substance may be to transfer color via a second colorant transfer mechanism, different to the first colorant transfer mechanism.

At block 1004, the printing device is operated in accordance with the selected operating mode.

Any feature described in relation to any one example may be used alone, or in combination with other features described, and may also be used in combination with a feature or features of any other of the examples, or any combination of any other of the examples. Furthermore, equivalents and modifications not described above may also be employed.

What is claimed is:

1. A printing device comprising a first printhead, a second printhead, and a controller;
wherein the printing device is to operate in a first operating mode in which the first printhead is to dispense a first printing substance, the first printing substance to transfer color via a first colorant transfer mechanism, and to operate in a second operating mode in which the second printhead is to dispense a second printing substance, the second printing substance to transfer color via a second colorant transfer mechanism different to the first colorant transfer mechanism; and
wherein the controller is to cause the printing device to operate in a selected one of the first and second operating modes.

2. A printing device according to claim 1, wherein the first printing substance comprises a first ink vehicle and the second printing substance comprises a second ink vehicle different to the first ink vehicle.

3. A printing device according to claim 1, wherein the first printing substance is a latex ink and the second printing substance is a dye sublimation ink.

4. A printing device according to claim 1, wherein the first printing substance is a latex ink and the second printing substance is an ultraviolet-curable ink.

5. A printing device according to claim 1, wherein the first printing substance is an ultraviolet-curable ink and the second printing substance is a dye sublimation ink.

6. A printing device according to claim 1, comprising a curing module to operate in a first curing mode when the printing device is operated in the first operating mode, and to operate in a second curing mode when the printing device is operated in the second operating mode.

7. A printing device according to claim 1, wherein the controller is to cause the printing device to operate in a selected one of the first and second operating modes on the basis of a selected substrate.

8. A printing device according to claim 1, wherein the printing device is to operate in a third operating mode in which the printing device is to perform a printing event in which the first printhead is to dispense the first printing substance and in which the second printhead is to dispense the second printing fluid, and wherein the controller is to cause the printing device to operate in a selected one of the first, second and third operating modes.

9. A printing device comprising:
a first printhead to print a first printing substance to transfer color via a first colorant transfer mechanism;
a second printhead to print a second printing substance to transfer color via a second colorant transfer mechanism different to the first colorant transfer mechanism; and
a curing module to operate in a first operating mode to fix the first printing substance when the first printhead is used to print the first, printing substance, and to operate in a second operating mode, different to the first operating mode, to fix the second printing substance when the second printhead is used to print the second printing substance.

10. A printing device according to claim 9, wherein, in the first operating mode, the curing module is to heat the first printing substance to a first maximum temperature and, in the second operating mode, the curing module is to heat the second printing substance to a second maximum temperature, different to the first maximum temperature.

11. A printing device according to claim 9, wherein, in the first operating mode, the curing module is to heat the first printing substance to a maximum temperature in the range 80° C.-125° C. and, in the second operating mode, the curing module is to heat the second printing substance to a maximum temperature in the range 150° C.-220° C.

12. A printing device according to claim 9, wherein, in the first curing mode, the curing module is to apply heat to the first printing substance for a first maximum length of time and, in the second operating mode, the curing module is to apply heat to the second printing substance for a second maximum length of time, different to the first maximum length of time.

13. A printing device according to claim 9, wherein, in the first curing mode, the curing module is to direct hot air to the first printing substance and, in the second operating mode, the curing module is to irradiate the second printing substance with electro magnetic radiation.

14. A printing device according to claim 13, wherein the electromagnetic radiation comprises one of infrared radiation and ultraviolet radiation.

15. A method of operating a printing device, the method comprising:
selecting one of a plurality of operating modes of the printing device, the operating modes comprising:
a first operating mode in which a first printing substance is dispensed from a first printhead of the printing device, the first printing substance to transfer color via a first colorant transfer mechanism; and
a second operating mode in which a second printing substance is dispensed from a second printhead of the printing device, the second printing substance to transfer color via a second colorant transfer mechanism different to the first colorant transfer mechanism; and
operating the printing device in accordance with the selected operating mode.
